(19) United States
(12) Patent Application Publication
(10) Pub. No.: US 2016/0188950 A1
(43) Pub. Date: Jun. 30, 2016

(54) OPTICAL FINGERPRINT RECOGNITION DEVICE

(71) Applicant: Quanta Computer Inc., Taoyuan City (TW)

(72) Inventors: Yun-Cheng Liu, Taoyuan City (TW); Chin-Kang Chang, Taoyuan City (TW); Chao-Ching Huang, Taoyuan City (TW)

(21) Appl. No.: 14/619,380

(22) Filed: Feb. 11, 2015

(30) Foreign Application Priority Data
Dec. 30, 2014 (TW) 103146192

(51) Int. Cl. G06K 9/00; H04N 5/225; G02B 13/00

(52) U.S. Cl. CPC G06K 9/00013; G02B 13/0015; H04N 5/2254; G06K 9/00087

(57) ABSTRACT

An optical fingerprint recognition device is provided. The optical fingerprint recognition device includes: an optical sensing surface; a first optical detection module having a first lens and a first optical sensor; and a second optical detection module having a second lens and a second optical sensor. The first optical detection module and the second optical detection module are arranged side by side in the optical fingerprint recognition device, and the first optical detection module and the second optical detection module are configured to capture a first fingerprint image and a second fingerprint image of a user's finger on a sensing area of the optical sensing surface for fingerprint recognition.

### CROSS REFERENCE TO RELATED APPLICATIONS

This Application claims priority of Taiwan Patent Application No. 103146192, filed on Dec. 30, 2014, the entirety of which is incorporated by reference herein.

### BACKGROUND OF THE INVENTION

1. Field of the Invention

The present invention relates to an optical system, and, in particular, to an optical fingerprint recognition device.

2. Description of the Related Art

In recent years, fingerprint recognition technology has been widely used in mobile devices such as smartphones, tablet PCs, and laptop computers. Conventionally, capacitive sensors or optical sensors are used in a fingerprint recognition device to capture fingerprint images of a user's finger. FIG. 1 is a diagram of a conventional optical fingerprint recognition device. The conventional optical fingerprint recognition device 100 comprises an optical sensing surface 110, and an optical sensor 120. The optical sensor 120 is configured to capture a fingerprint image of a user's finger on a sensing area of the optical sensing surface 110. The conventional optical fingerprint recognition device 100 only comprises a single optical sensor 120, and the field of view of the optical sensor 120 is fixed. Accordingly, the distance between the sensing area and the optical sensor 120 should be designed to be within an appropriate range. However, a lower height and weight of current mobile devices in the market are in high demand. If a conventional optical fingerprint recognition device 100 is used, the distance between the sensing area of the optical sensing surface 110 and the optical sensor 120 cannot be shortened. If the distance between the sensing area 111 of the optical sensing surface 110 and the optical sensor 120 is shortened improperly, the module height of the conventional fingerprint recognition device 100 is lowered, resulting in distortion of the captured fingerprint images due to a larger detection angle of the optical sensor 120. Accordingly, the optical sensor 120 cannot retrieve an accurate fingerprint image, and thus it is difficult to retrieve the characteristics of the fingerprint images.

Therefore, there is a demand for an optical fingerprint recognition device to solve the aforementioned issues of the conventional fingerprint recognition device.

### BRIEF SUMMARY OF THE INVENTION

A detailed description is given in the following embodiments with reference to the accompanying drawings.

In an exemplary embodiment, an optical fingerprint recognition device is provided. The optical fingerprint recognition device includes: an optical sensing surface; a first optical detection module having a first lens and a first optical sensor; and a second optical detection module having a second lens and a second optical sensor. The first optical detection module and the second optical detection module are arranged side by side in the optical fingerprint recognition device, and the first optical detection module and the second optical detection module are configured to capture a first fingerprint image and a second fingerprint image of a user's finger on a sensing area of the optical sensing surface for fingerprint recognition.

In another exemplary embodiment, an optical fingerprint recognition device is provided. The optical fingerprint recognition device includes: an optical sensing surface; and an optical detection module comprising a first lens and a corresponding first optical sensor, and a second lens and a corresponding second optical sensor. The first optical sensor and the second optical sensor capture a first fingerprint image and a second fingerprint image of a user's finger on a sensing area of the optical sensing surface via the first lens and the second lens for fingerprint recognition, respectively.

In yet another exemplary embodiment, an optical fingerprint recognition device is provided. The optical fingerprint recognition device includes: an optical sensing surface; and an optical detection module comprising a first lens and a corresponding first optical sensor, and a second lens and a corresponding second optical sensor. The first optical sensor and the second optical sensor capture a first fingerprint image and a second fingerprint image of a user's finger on a sensing area of the optical sensing surface via the first lens and the second lens for fingerprint recognition, respectively.

In yet another exemplary embodiment, an optical fingerprint recognition device is provided. The optical fingerprint recognition device includes: an optical sensing surface; and an optical detection module, comprising a plurality of lenses and an optical sensor. The optical sensor captures a fingerprint image of a user's finger on a sensing area of the optical sensing surface via each lens for fingerprint recognition, wherein each fingerprint image captured by the optical sensor via each lens is a portion of an image window, and each fingerprint image does not overlap with each other.

### BRIEF DESCRIPTION OF THE DRAWINGS

The present invention can be more fully understood by reading the subsequent detailed description and examples with references made to the accompanying drawings, wherein:

FIG. 1 is a diagram of a conventional optical fingerprint recognition device;

FIG. 2 is a block diagram of an optical fingerprint recognition device in accordance with an embodiment of the invention;

FIG. 3 is a block diagram of an optical fingerprint recognition device in accordance with another embodiment of the invention;

FIG. 4 is a block diagram of an optical fingerprint recognition device in accordance with yet another embodiment of the invention;

FIG. 5 is a diagram illustrating capturing of images in different fields of view using different lenses in accordance with an embodiment of the invention; and

FIG. 6 is a diagram illustrating capturing of images in different fields of view using different lenses in accordance with another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

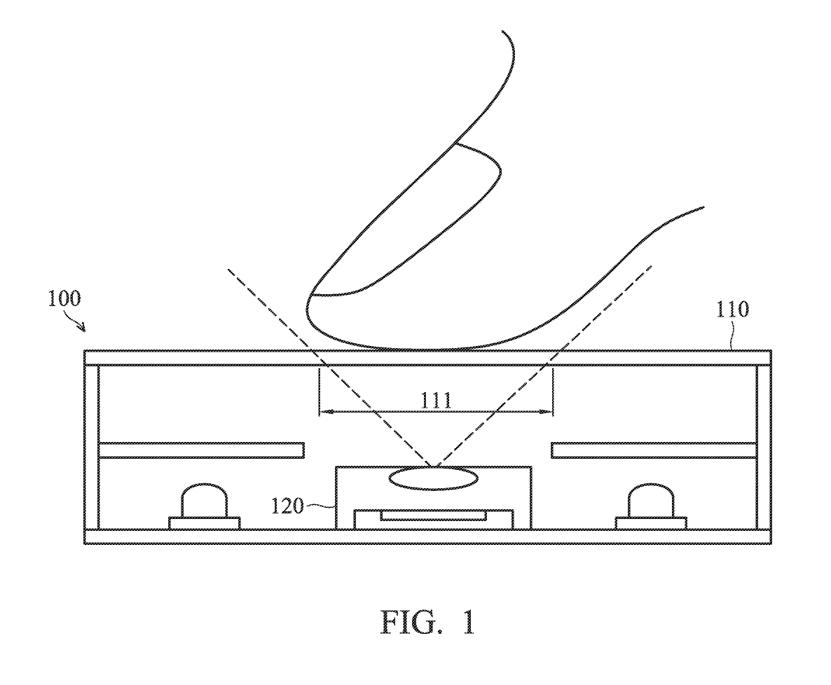

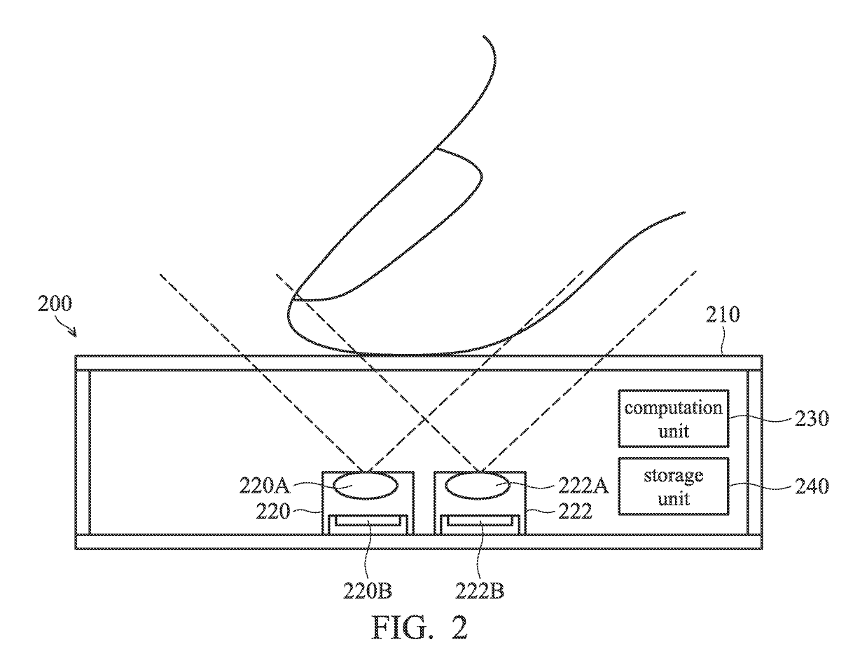

FIG. 2 is a block diagram of an optical fingerprint recognition device in accordance with an embodiment of the invention. The optical fingerprint recognition device 200 comprises an optical sensing surface 210, optical detection modules 220 and 222, an computation unit 230, and a storage unit 240. Each of the optical detection modules 220 and 222 comprises a lens and an optical sensor. The lens 220A and 222A and corresponding optical sensors 220B and 222B, as shown in FIG. 1, are configured to detect fingerprint images of a user's finger touching on a sensing area on the optical sensing surface 210. For example, the sensing area may be on the surface or a specific region of a display. The computation unit 230 analyzes the fingerprint images detected by the optical sensors 220B and 222B, and performs corresponding image processing. The storage unit 240 comprises a user fingerprint database which records a user's fingerprint images or corresponding user fingerprint information (e.g. biometric points of fingerprint images).

For example, since the computation unit 230 has to analyze different fingerprint images from different optical detection modules, such as the first fingerprint image from the optical detection module 220 and the second fingerprint image from the optical detection module 222. The computation unit 230 performs image synthesis to the first fingerprint image and the second fingerprint image to generate a synthesized fingerprint image, and performs subsequent image processing on the synthesized fingerprint image, such as binary coding, smoothing, and thinning Afterwards, the computation unit 230 further calculates biometric points of the synthesized fingerprint image, such as ridges, bifurcations, and intersections. Then, the computation unit 230 matches the calculated biometric points with the user fingerprint information pre-stored in the storage unit 240. When the calculated biometric points match the user fingerprint information, the computation unit 230 determines that the fingerprint recognition is approved. When the calculated biometric points do not match the user fingerprint information, the computation unit 230 determines that the fingerprint recognition is not approved.

Specifically, the optical detection modules 220 and 222 are arranged in parallel. That is the overall field of view of the optical detection device can be extended to the fields of view of the lenses 220A and 222A. For example, the field of view of the lens 220A is between dashed lines 20 and 21, and the field of view of the lens 222A is between the dashed lines 22 and 23. Regarding the synthesized fingerprint image, the overall optical viewing angle is larger than that of the first fingerprint image or the second fingerprint image. Accordingly, the height of the optical fingerprint recognition device 200 can be reduced. That is, distortion of the captured fingerprint image can be avoided using a lower module height.

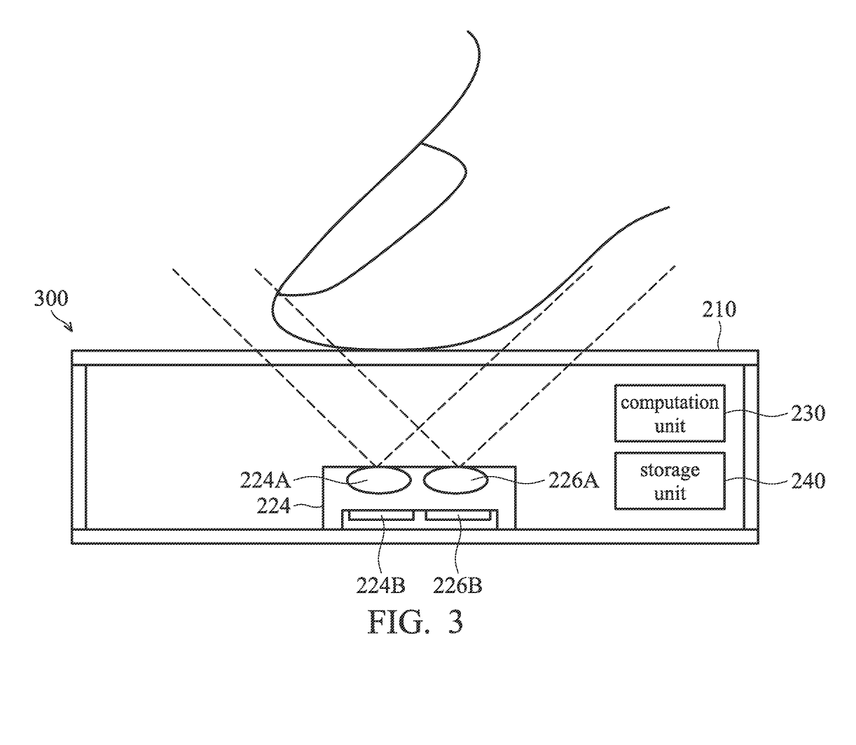

FIG. 3 is a block diagram of an optical fingerprint recognition device in accordance with another embodiment of the invention. The optical fingerprint recognition device 300 is similar to the optical fingerprint recognition device 200, and the difference is that the optical detection modules 220 and 222 shown in FIG. 2 are replaced by the optical detection module 224 shown in FIG. 3. The optical detection module 224 is an integrated optical module which comprises two lenses 224A and 226A and corresponding optical sensors 224B and 226B. It should be noted that the optical axes of the lenses 224A and 226A are arranged in parallel, and are perpendicular to the optical sensing surface 210.

The optical sensors 224B and 226B capture the first fingerprint image and the second fingerprint image through the lenses 224A and 226A, respectively. The corresponding image processing and biometric-point-matching performed by the computation unit can be referred to in the aforementioned embodiments, and thus the details will be omitted here.

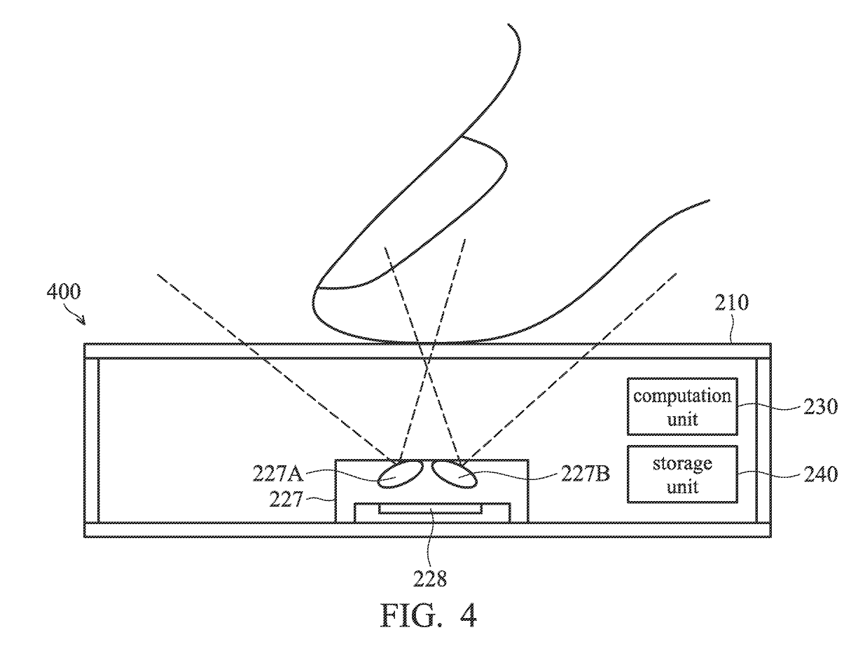

FIG. 4 is a block diagram of an optical fingerprint recognition device in accordance with yet another embodiment of the invention. The optical fingerprint recognition device 400 is similar to the optical fingerprint recognition device 300. The difference is that the optical detection modules 222 and 224 shown in FIG. 3 are replaced by the optical detection module 227 shown in FIG. 4.

The optical detection module 227 is also an integrated optical module, which is analogous to the optical detection module 224 in FIG. 3. The optical detection module 227 comprises two lenses 227A and 227B, and a corresponding optical sensor 228. It should be noted that the optical axis of the lenses 227A and 227B is arranged so that there is a predetermined angle between the two optical axes, and the fingerprint images are captured by the optical sensor 228 via the lenses 227A and 227B. Specifically, the lenses 227A and 227B can be disposed to capture a fingerprint images in a predetermined field of view, respectively. The optical sensor 228 captures the first fingerprint image and the second fingerprint image via the lenses 227A and 227B, respectively. The corresponding image processing and biometric-point-matching performed by the computation unit can be referred to in the aforementioned embodiments, and thus the details will be omitted here.

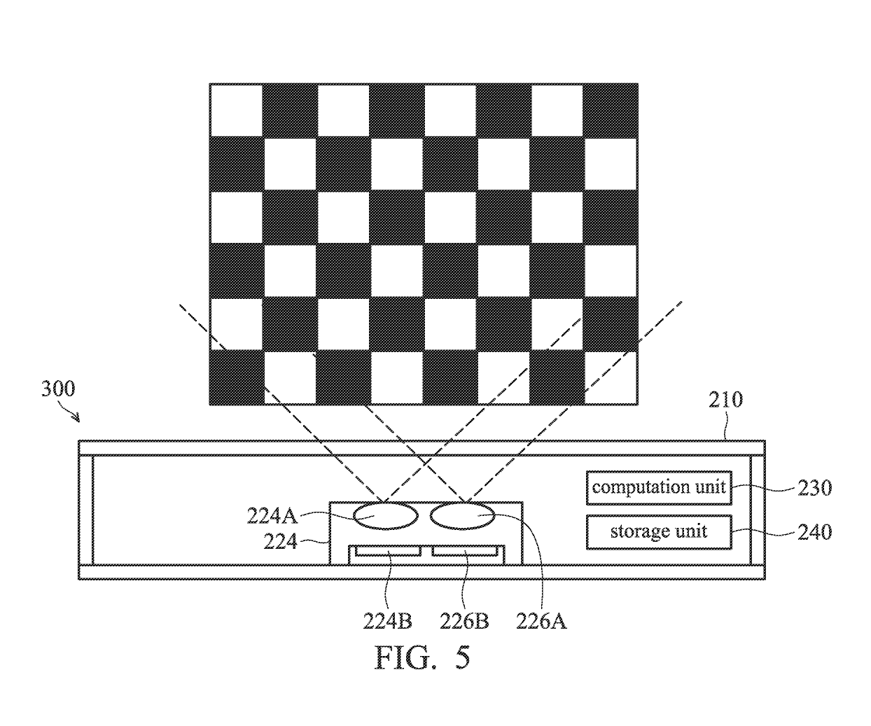

FIG. 5 is a diagram illustrating capturing of images in different fields of view using different lenses in accordance with an embodiment of the invention. In an embodiment, the optical detection module 300 shown in FIG. 3 may comprise a different number of lenses which are arranged in different ways. For example, the lenses can be arranged in a 1×2 grid, a 2×2 grid, or another grid format, but the invention is not limited thereto. It should be noted that each lens is used to capture a fingerprint image in a predetermined specific field of view, and each lens has a corresponding optical sensor.

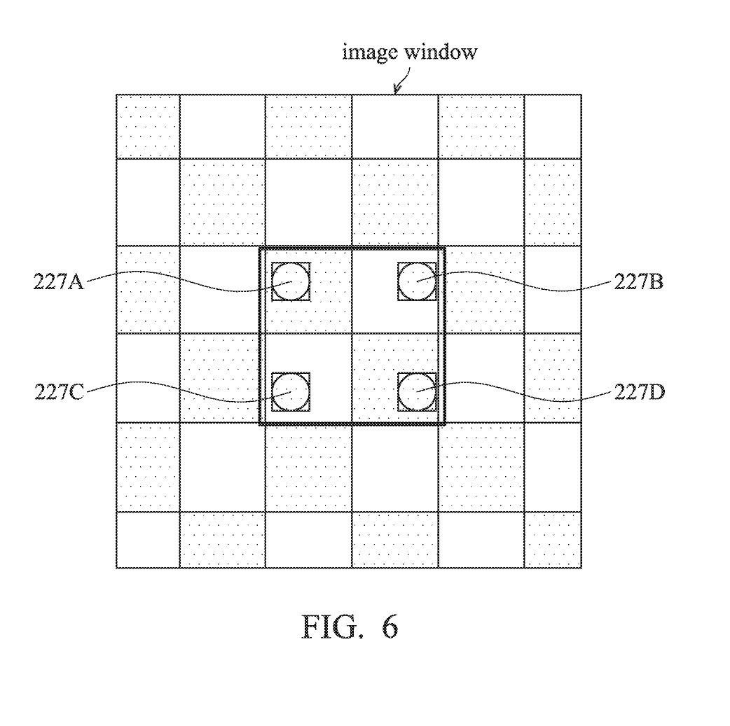

FIG. 6 is a diagram illustrating capturing of images in different fields of view using different lenses in accordance with another embodiment of the invention. In an embodiment, the optical detection module 400 shown in FIG. 4 may comprise different numbers of lenses which are arranged in different ways. For example, the lenses can be arranged in a 1×2 grid, a 2×2 grid, or another grid format, but the invention is not limited thereto. It should be noted that each lens is used to capture a fingerprint image in a predetermined specific field of view, and each lens corresponds to the same optical sensor. For example, the lenses 227A, 227B, 227C and 227D corresponds to a specific portion of the image window, and the same optical sensor 228 captures different fingerprint images via the lenses 227A, 227B, 227C, and 227D, and each captured fingerprint image does not overlap with each other. The computation unit 230 may synthesize the fingerprint images captured by different lenses to generate a synthesized image window, which is an integrated fingerprint image.

In view of the above, an optical fingerprint recognition device is provided. The optical fingerprint recognition device is capable of extending the overall range of the captured fingerprint image using multiple optical detection modules or a single optical detection module comprising multiple lenses, so that the overall height of the optical fingerprint recognition device can be lowered without distortion of captured fingerprint images.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical fingerprint recognition device, comprising:
an optical sensing surface;
a first optical detection module, comprising a first lens and a first optical sensor; and
a second optical detection module, comprising a second lens and a second optical sensor,
wherein the first optical detection module and the second optical detection module are arranged side by side in the optical fingerprint recognition device, and the first optical detection module and the second optical detection module are configured to capture a first fingerprint image and a second fingerprint image of a user's finger on a sensing area of the optical sensing surface for fingerprint recognition.

2. The optical fingerprint recognition device as claimed in claim 1, further comprising:
a computation unit, configured to synthesize the first fingerprint image and the second fingerprint image to an integrated fingerprint image, and perform image processing on the integrated fingerprint image to retrieve biometric points of the integrated fingerprint image.

3. The optical fingerprint recognition device as claimed in claim 2, further comprising:
a storage unit, configured to store user fingerprint information,
wherein the computation unit further determines whether the biometric points match the user fingerprint information,
if the biometric points match the user fingerprint information, the computation unit determines that the fingerprint recognition of the user's finger is approved.
if the biometric points do not match the user fingerprint information, the computation unit determines that the fingerprint recognition of the user's finger is not approved.

4. An optical fingerprint recognition device, comprising:
an optical sensing surface; and
an optical detection module, comprising a first lens and a corresponding first optical sensor, and a second lens and a corresponding second optical sensor,
wherein the first optical sensor and the second optical sensor capture a first fingerprint image and a second fingerprint image of a user's finger on a sensing area of the optical sensing surface via the first lens and the second lens for fingerprint recognition, respectively.

5. The optical fingerprint recognition device as claimed in claim 4, wherein the first lens and the second lens are arranged side by side in the optical fingerprint recognition device, and optical axes of the first lens and the second lens are arranged in parallel and are perpendicular to the optical sensing surface.

6. An optical fingerprint recognition device, comprising:
an optical sensing surface; and
an optical detection module, comprising a first lens and a corresponding first optical sensor, and a second lens and a corresponding second optical sensor,
wherein the first optical sensor and the second optical sensor capture a first fingerprint image and a second fingerprint image of a user's finger on a sensing area of the optical sensing surface via the first lens and the second lens for fingerprint recognition, respectively.

7. The optical fingerprint recognition device as claimed in claim 6, wherein the first lens and the second lens are arranged side by side in the optical fingerprint recognition device, and there is a predetermined angle between axes of the first lens and the second lens.

8. The optical fingerprint recognition device as claimed in claim 6, further comprising:
a computation unit, configured to synthesize the first fingerprint image and the second fingerprint image to an integrated fingerprint image, and perform image processing on the integrated fingerprint image to retrieve biometric points of the integrated fingerprint image.

9. The optical fingerprint recognition device as claimed in claim 8, further comprising:
a storage unit, configured to store user fingerprint information,
wherein the computation unit further determines whether the biometric points match the user fingerprint information,
if the biometric points match the user fingerprint information, the computation unit determines that the fingerprint recognition of the user's finger is approved,
if the biometric points do not match the user fingerprint information, the computation unit determines that the fingerprint recognition of the user's finger is not approved.

10. An optical fingerprint recognition device, comprising:
an optical sensing surface; and
an optical detection module, comprising a plurality of lenses and an optical sensor,
wherein the optical sensor captures a fingerprint image of a user's finger on a sensing area of the optical sensing surface via each lens for fingerprint recognition,
wherein each fingerprint image captured by the optical sensor via each lens is a portion of an image window, and each fingerprint image does not overlap with each other.
